(19) United States
(12) Patent Application Publication
(10) Pub. No.: US 2006/0010963 A1
(43) Pub. Date: Jan. 19, 2006

(54) Measurement of viscosity using magnetostrictive particle sensors

(76) Inventors: David T. Bach, Ellicott City, MD (US); Muniswamappa Anjanappa, Ellicott City, MD (US)

Correspondence Address: Clifford Kraft, 320 Robin Hill Dr., Naperville, IL, 60540, US

(21) Appl. No.: 10/965,289

(22) Filed: Oct. 14, 2004

Related U.S. Application Data
(60) Provisional application No. 60/588,950, filed on Jul. 19, 2004.
(60) Provisional application No. 60/511,565.

(51) Int. Cl. G01N 11/00

(52) U.S. Cl. 73/54.01

(57) ABSTRACT

A system for making dynamic measurement of viscosity or density of a fluid using magnetostrictive particles. Magnetostrictive particles are placed in contact or proximity with a fluid where they can experience stress caused by the viscosity of the fluid when they expand, contract or otherwise move. A alternating or otherwise changing magnetic field is applied to the system causing the particles to expand and contract. A sense coil detects a total magnetic field that is a superposition of the applied field and a field generated in the magnetostrictive particles as they expand and contract. The amplitude of this sensor is related to the viscosity. The applied magnetic field can also be swept in frequency with the location of a resonance also indicating viscosity or density.

This application is related to and claims priority from U.S. Provisional application 60/588,950 filed Jul. 19, 2004 and 60/511,565 filed Oct. 15, 2003. Application 60/588,950 and 60/511,565 are hereby incorporated by reference.

### BACKGROUND

1. Field of the Invention

The present invention relates generally to the field of viscosity measurement and more particularly to dynamic measurement of viscosity and density of fluids using magnetostrictive particle sensors.

2. Description of the Prior Art

There are numerous field applications that require precision dynamic measurement of viscosity or density of fluids. They include point-of-care measurement of blood coagulation, detection of gases in ambient air, gas chromatography, and liquid chromatography.

Previous investigators have used piezoelectric material-based systems for viscosity and density measurements.

Although some instruments are known in the art, there exists a need for a more accurate and economical system that can measure the viscosity and density in real time, especially for point-of-care and end-user applications. What is badly needed is a high precision, dynamic viscosity and density measurement system that exploits the unique features of magnetostrictive material.

Magnetostrictive material is usually an alloy of terbium, dysprosium and ferrite. Magnetostriction is the property that causes the magnetostrictive material to change physical shape in the presence of an applied magnetic field. Terfenol-D is a commercially available magnetostrictive material discovered by the Naval Ordnance Laboratory. Terfenol-D can elongate up to around 2000 ppm when subjected to magnetic field so around 2500 Orested. In addition, when a magnetostrictive material is mechanically loaded, it self-generates a magnetic field. If the loading is the result of an applied magnetic field, the total field is the superposition of the applied field and the self-generated field.

These two modes of operation allow magnetostrictive material to convert mechanical energy to magnetic energy and to convert magnetic energy to mechanical energy.

### SUMMARY OF THE INVENTION

The present invention relates to a liquid viscosity or density measurement system where a liquid sample is measured by means of a magnetic field source that is applied to the liquid creating an applied magnetic field that permeates the liquid. Magnetostrictive particles are placed in contact with said liquid or in a structure that is in contact with the liquid. The magnetic field also permeates the magnetostrictive particles. An output coil is placed in proximity to the magnetostrictive particles where it senses the total magnetic field and produces a voltage proportional to the viscosity of said liquid. Normally the applied magnetic field changes in time and is sinusoidal.

### DESCRIPTION OF THE FIGURES

FIG. 1 shows a magnetostrictive dynamic viscosity and density measurement system.

FIG. 2 is a block diagram of a magnetostrictive dynamic viscosity and density measurement system.

FIG. 3 is a stress-strain curve for typical magnetostrictive material

FIG. 4 is a graph of magnetic flux density vs. magnetic field intensity for different pre-stress levels.

FIG. 5 shows a flat plate magnetostrictive system.

Certain illustrations and figures have been presented to better aid in the understanding of the present invention. The scope of the present invention is not limited to the figures.

### DESCRIPTION OF THE INVENTION

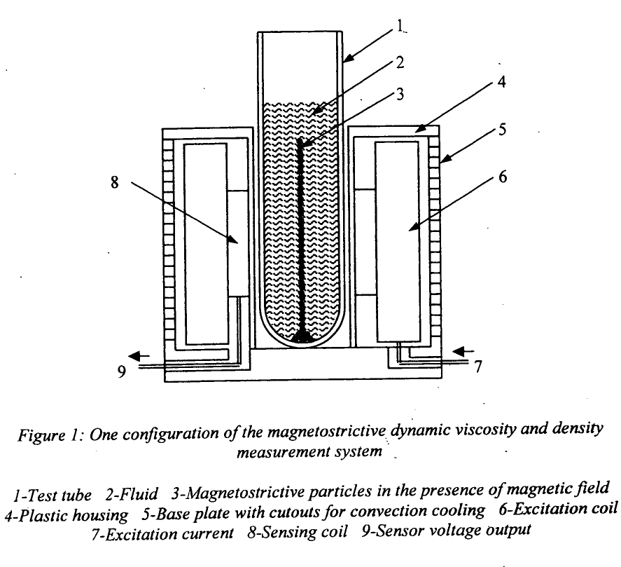

A system for magnetostrictive dynamic viscosity and density measurement of fluids can be configured in different ways depending on the application. One representative application is the measurement of blood coagulation or clotting time. FIG. 1 shows an embodiment of a system the can measure blood coagulation time.

A test tube 1 containing blood 2 (or other liquid), coagulation agent 2, and a predetermined quantity of magnetostrictive particles 3 of a known size can be inserted a magnetostrictive dynamic viscosity and density measurement system. The magnetostrictive particles 3 can be used as is or sealed in a thin polymer shell that is compatible with the fluids to be tested (does not react with them). The particles can also be briskly shaken and sieved to improve the uniformity before being used. An excitation coil 6 can be energized by passing a current 7 (usually sinusoidal) through the coil. Alternating currents which may be sinusoidal will establish a carrier or applied magnetic field in the tube 1 and its ingredients. Since magnetostrictive particles' permeability is higher than that of the tube and the other ingredients, most of the magnetic field lines pass through the magnetostrictive particles.

The magnetostrictive particles 3 can respond in two ways: 1) align along the central axis of the excitation coil creating a least reluctance magnetic field path, and 2) elongate in the direction of the magnetic field due to their unique magnetostriction property. These two phenomena follow the changing magnetic field.

A sensing coil 8 can be placed around the test tube 1. This sensing coil can produce an output voltage 9 at its output proportional to the rate of change of total magnetic flux through it. The time-varying magnetic field from the excitation coil 6 induces a first component of the output voltage across the sensing coil 8. A second component of the output voltage is produced by what is known as the “Villari Effect” where the magnetostrictive material generates a magnetic field when it is mechanically loaded. The first component depends on the geometry of the coil and the permeability of the tube and its ingredients (excluding the magnetostrictive particles). Since these factors remain constant during the coagulation process, the first component of the output voltage merely reflects the driving current 7 in the excitation coil 6.

The second component of the output voltage 9 depends on the stress level and permeability of the magnetostrictive particles. The stress level in the magnetostrictive particles 3 in turn depends on the strength of the driving magnetic field and how much physical resistance to expansion and contraction that the viscosity of the fluid 2 exerts on them. As the fluid coagulates, the viscosity increases. In the case of blood, this is caused the formation of a fibrin network in the clotting blood. As the apparent viscosity of the fluid increases, there is increased physical resistance to expansion and contraction. This phenomenon causes a voltage change at the sensor coil output 9. The change in voltage level can be nearly directly proportional to viscosity changes occurring in the fluid 2. This offers a convenient way to measure the viscosity dynamically without interfering with the formation of the fibrin network, and hence monitor the progress and time of the coagulation process.

The movement of the magnetostrictive particles 3 do to the changing (possibly sinusoidal) excitation field also helps in mixing the fluid more uniformly. This mixing action improves the overall accuracy of the measurement, especially for peripheral blood (e.g. finger stick blood) where tissue is a factor. To improve the mixing effect, the present invention can optionally be modified to include a commutated motor action or include rotating mixing magnets.

Increased viscosity and increased stress on the magnetostrictive particles also causes a change in the resonant frequency of the particles. By performing a sweeping operation over a frequency range with the driving current 7 into the excitation coil 6, the resonance can be located. As coagulation occurs, the frequency value of the resonant changes and can be tracked. The change in resonant frequency can be also nearly directly proportional to the viscosity of the fluid 2.

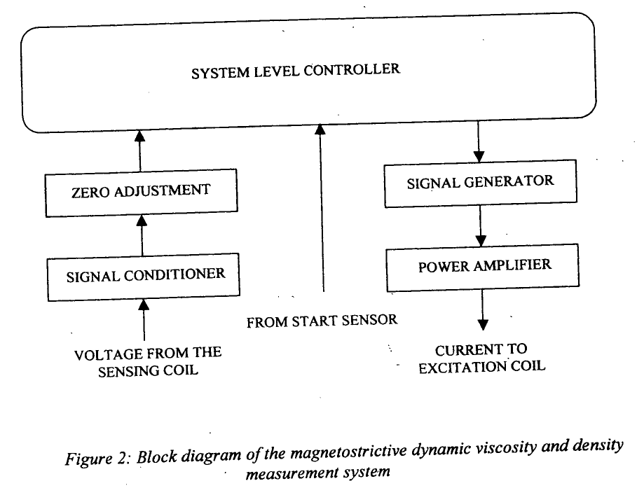

FIG. 2 shows block diagram of a magnetostrictive dynamic viscosity and density measurement system. The system level controller in this embodiment can be a personal computer (PC) or any other type of computer, microcontroller or controller. An embodiment of such a system can be as simple as a single board controller to a full-fledged data acquisition and control system.

FIG. 2 shows a signal conditioner and zero adjustment for the voltage from the sensing coil 8. The zero adjustment can also be done in software, and is, in any case, optional. FIG. 2 shows the excitation coil driver in the form of a signal generator and a power amplifier. Any method of creating an applied magnetic field is within the scope of the present invention. Current from the power amplifier can be used to directly drive the excitation coil 6.

Once the test tube 1 or fluid container is placed in the housing 4, a proximity sensor can send a signal to a system level controller signifying the start of the process. This controller can then begin the process of measuring the viscosity by sending a command to the signal generator. The output signal from the signal generator can be fed to a power amplifier to cause drive current 7 to pass through the excitation coil 6. The sensing coil output voltage 9 can be processed through a signal-conditioning unit to clean up the signal and amplify it. The cleaned, amplified signal can then be fed into an optional zero adjustment circuit to maintain the desired sensitivity before reaching the system level controller.

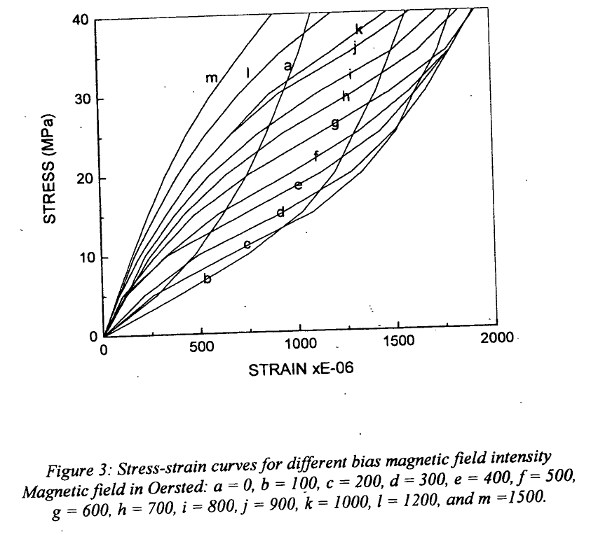

FIG. 3 shows a typical stress-strain curve for different biases in magnetic field intensities with a typical magnetostrictive material. It can be seen that there is normally a non-linear relationship between stress and strain. FIG. 3 also shows the relationship between the magnetostriction magneto mechanical coupling coefficient (slope) and the applied magnetic field non-linear stress.

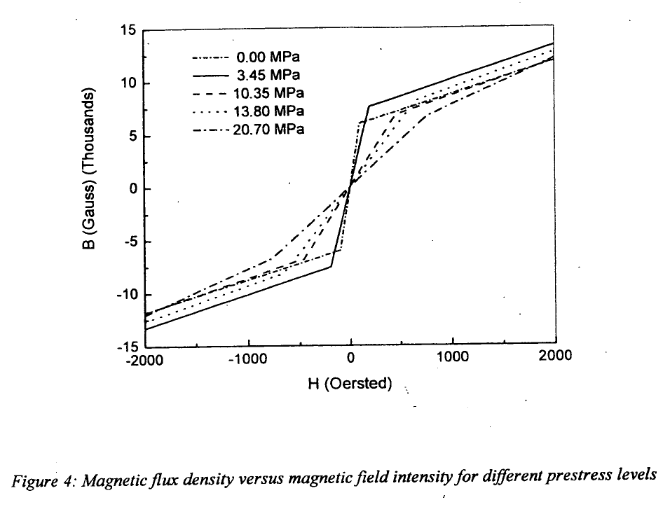

FIG. 4 shows the relationship between the magnetic flux density and the magnetic field intensity for various levels of pre-stress. FIG. 4 makes apparent the relationship between the permeability (slope) and the magnetic field. The system level controller in FIG. 2 can contain algorithms to account for these non-linear effects.

The output of the sensing coil 8 may typically be an AC signal with a superimposed voltage change that is proportional to the change in viscosity or density. To maximize the sensitivity of the system, the sensing coil output signal 9 can first be rectified and then filtered followed by a zero adjustment. One way of achieving a zero adjustment is to subtract out the carrier signal. An adjustable zero reference provides an easy way to maximize the sensitivity of the sensor.

In the case of a frequency domain measurement (swept system), the change in resonance can be measured by a hardware circuit or it can be measured in software. Generally it is desirable to perform this resonance determination in real time. The choice of an amplitude or frequency method depends on the type of fluid and the sensitivity desired. Both methods are within the scope of the present invention.

It should be noted that the excitation and sensing coils can be arranged in many ways differently from what is shown in FIG. 1. All of these arrangements are within the scope of the present invention. For example, the sensing coil could be placed outside the excitation coil thereby reducing the energy required to excite the system, but possibly making the sensing process less sensitive. Also the excitation coil can be split into two parts with the sensing coil located in the middle in the longitudinal direction. It is also possible to wind both coils together. The wires used to wind the two coils can be the same or different diameters. The test tube shown in FIG. 1 can be replaced with other shapes including shapes with a flat bottom that could improve uniformity of the magnetic field. Various materials can be used for the test tube including glass, plastic or any other non-magnetic or fairly low permeability material.

The system can be fabricated conventionally or by using MEMS technology for cost and volume efficiency.

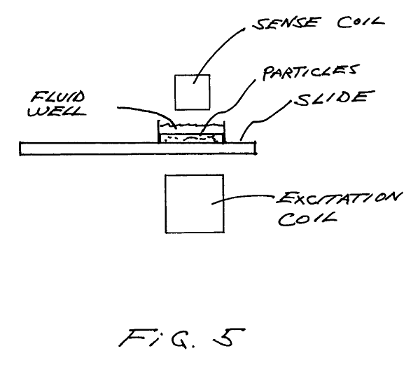

As an alternate to the embodiments presented thus far, reagents containing magnetostrictive materials can be deposited as layers of thicknesses of less than 0.1 micron to around 5 micron or greater on flat surfaces. An excitation coil(s) and a sensing coil(s) can be located external to the surface. The surface could be as simple as a throw-away slide. An embodiment of such a system is shown in FIG. 5.

Various descriptions and illustrations have been presented to better aid in the understanding of the present invention. One skilled in the art would understand that many changes and variations are possible. The scope of the present invention includes these changes and variations.

We claim:

1. A liquid viscosity measurement system comprising:
a liquid sample to be measured;
a magnetic field source creating an applied magnetic field that permeates said liquid;
a plurality of magnetostrictive particles in proximity with said liquid, said magnetic field also permeating said magnetostrictive particles;
an output coil in proximity to said magnetostrictive particles sensing a total magnetic field, said output coil producing a voltage proportional to the viscosity of said liquid.

2. The system of claim 1 wherein said applied magnetic field changes in time.

3. The system of claim 2 wherein said applied magnetic field is sinusoidal.

4. The system of claim 1 wherein said system measures blood coagulation.

5. The system of claim 1 wherein said voltage from said output coil passes through a signal conditioner.

6. The system of claim 1 wherein said liquid sample is in a container.

7. The system of claim 1 wherein said liquid sample is on a surface.

8. An apparatus for measuring viscosity or density of a liquid comprising:
a container holding a sample of said liquid;
a means for producing an applied magnetic field, said applied magnetic field passing through said liquid;
a magnetostrictive material in proximity to said liquid, said magnetostrictive material experiencing stress related to the viscosity of said liquid;
a means for measuring a total magnetic field containing components from said applied magnetic field and components from said magnetostrictive material;
a means for determining viscosity from said total magnetic field.

9. The apparatus of claim 8 wherein said sample is in a container.

10. The apparatus of claim 8 wherein said means for producing an applied magnetic field is an excitation coil.

11. The apparatus of claim 8 wherein said means for measuring a total magnetic field is a sensing coil.

12. The apparatus of claim 8 wherein said magnetostrictive material comprises a plurality of magnetostrictive particles.

13. The apparatus of claim 8 further comprising a means for causing said applied magnetic field periodically change in time and to sweep in frequency.

14. A method for measuring the viscosity or density of a fluid comprising the steps of:
placing a plurality of magnetostrictive particles in contact with a fluid sample;
causing an applied magnetic field to pass through said fluid sample and said magnetostrictive particles;
measuring a value of a total magnetic field as a combination of said applied alternating magnetic field and a magnetic field produced by said magnetostrictive particles;
determining the viscosity or density of said fluid from said value of said total magnetic field.

15. The method of claim 14 wherein said applied magnetic field changes in time.

16. The method of claim 15 wherein said applied magnetic field is sinusoidal.

17. The method of claim 14 further comprising measuring amplitude of said total magnetic field to determine viscosity or density of said fluid.

18. The method of claim 15 further comprising causing said applied magnetic field to sweep in frequency.

19. The method of claim 18 further comprising determining a resonance in said total magnetic field at a particular frequency.

20. The method of claim 19 further comprising using said particular frequency of said resonance to determine the viscosity or density of said fluid.
